(19) United States
(12) Patent Application Publication
(10) Pub. No.: US 2011/0316471 A1
(43) Pub. Date: Dec. 29, 2011

(54) BATTERY CONTROL SYSTEM

(76) Inventors: Yaun-Ren Yang, Taipei (TW); Ming Kao, Taipei (TW); Hsin-Kai Lai, Taipei (TW)

(21) Appl. No.: 12/840,299

(22) Filed: Jul. 21, 2010

(30) Foreign Application Priority Data
Jun. 28, 2010 (TW) 099121042

(51) Int. Cl. H01M 10/46

(52) U.S. Cl. 320/101

(57) ABSTRACT

A battery control system includes N batteries, N control switches, a solar energy charging module, and a processing module, wherein N is a positive integer larger than one. The N batteries are arranged in parallel, each of the control switches is connected to one of the batteries, and the solar energy charging module is connected to the control switches. The processing module is connected to the control switches and the solar energy charging module. The processing module selectively controls the i-th control switch to form a close circuit between the corresponding i-th battery and the solar energy charging module and controls the other N−1 control switches to form open circuits between the corresponding N−1 batteries and the solar energy charging module, wherein i is a positive integer smaller than or equal to N.

### BACKGROUND OF THE INVENTION

1. Field of the Invention

The invention relates to a battery control system and, more particularly, to a battery control system utilizing a solar energy charging module to charge one of a plurality of batteries.

2. Description of the Prior Art

Recently, with the global warming effect, green technology becomes a broadly-discussed topic, and development of green energy and alternative energy such as solar power, wind power and so on arise accordingly. Since the solar power and its relative application are getting more and more popular, the advanced countries have invested the solar energy related industries. In such a manner, various kinds of solar energy related products, especially for electronic devices, rise in human life gradually.

Generally speaking, electronic devices such as cell phone, laptop computer, personal digital assistant (PDA) and so on are powered by batteries. With development of solar energy related industries, some electronic devices are equipped with solar energy charging module and a plurality of serial-arranged or parallel-arranged batteries. When the batteries are out of electricity, the solar energy charging module can charge the batteries. However, when the conventional solar energy charging module charges multiple batteries simultaneously, the solar energy charging module cannot provide with a sufficient current for the multiple batteries, such that the batteries with insufficient electricity cannot be fully charged.

### SUMMARY OF THE INVENTION

An objective of the invention is to provide a battery control system utilizing a solar energy charging module to charge one of a plurality of batteries.

Another objective of the invention is to provide a battery control system capable of automatically detecting electricity of each battery so as to charge the battery with insufficient electricity.

According to one embodiment of the invention, the battery control system comprises N batteries, N control switches, a solar energy charging module and a processing module, wherein N is a positive integer larger than one. The N batteries are arranged in parallel, each of the control switches is connected to one of the batteries respectively, and the solar energy charging module is connected to the control switches. The processing module is connected to the control switches and the solar energy charging module. The processing module selectively controls the i-th control switch to form a close circuit between the corresponding i-th battery and the solar energy charging module and controls the other N−1 control switches to form open circuits between the other corresponding N−1 batteries and the solar energy charging module, wherein i is a positive integer smaller than or equal to N.

In this embodiment, the processing module can comprise a voltage detecting unit connected to the control switches. When M batteries of the batteries are idle (e.g. neither in charged state nor in power supplying state), the processing module controls the corresponding M control switches to form close circuits between the M batteries and the voltage detecting unit, wherein M is a positive integer smaller than N.

In summary, according to the battery control system of the invention, each of the multiple batteries is connected to the solar energy charging module via one corresponding control switch respectively. Accordingly, the solar energy charging module can charge one of the multiple batteries by switching operations of the control switches. Furthermore, the voltage detecting unit of the processing module can automatically detect electricity of each of the batteries by switching operations of the control switches, so as to control the solar energy charging module to charge the battery with insufficient electricity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a battery control system according to one embodiment of the invention.

FIG. 2 is a circuit diagram illustrating the three batteries being in charged state, power supplying state and idle state correspondingly.

FIG. 3 is a circuit diagram illustrating the three batteries being in idle state, charged state and power supplying state correspondingly.

### DETAILED DESCRIPTION

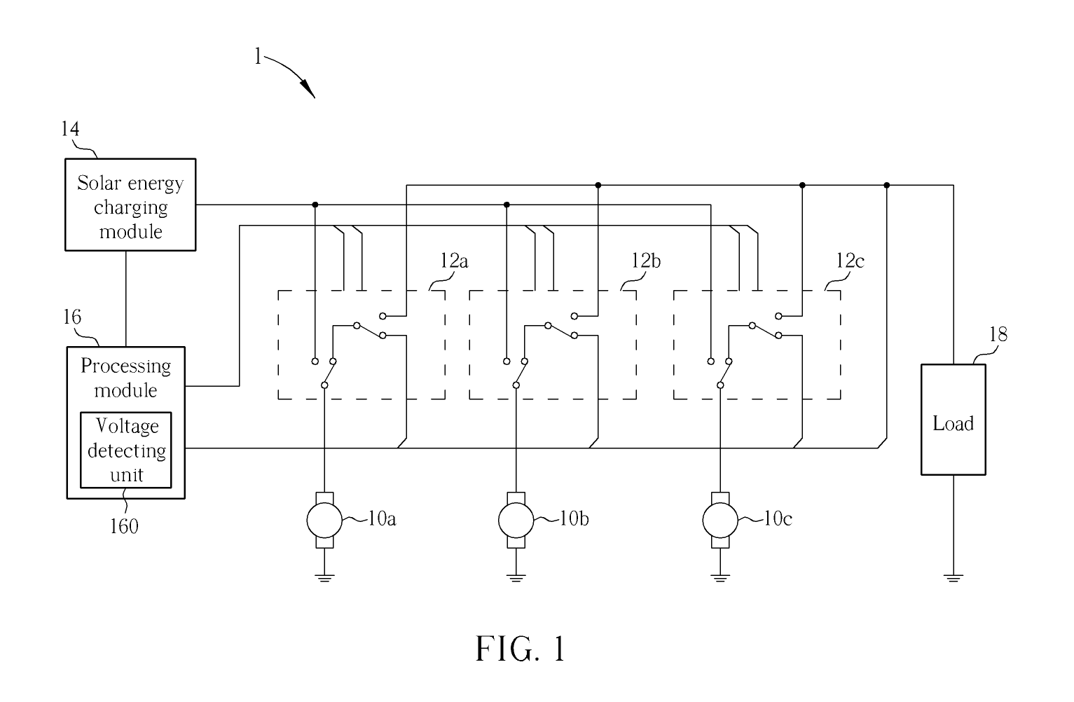

Referring to FIG. 1, FIG. 1 is a circuit diagram illustrating a battery control system 1 according to one embodiment of the invention. As shown in FIG. 1, the battery control system 1 comprises three batteries 10a-10c, three control switches 12a-12c, a solar energy charging module 14, a processing module 16 and a load 18. It should be noticed that the number of the batteries and the control switches is not limited to three and it can increase or decrease based on practical applications (at least two). Furthermore, the battery control system 1 can be applied to any electronic devices such as cell phone, laptop computer, personal digital assistant (PDA) and so on.

Each of the control switches 12a-12c is connected to one of the batteries 10a-10c respectively, and the solar energy charging module 14 is connected to the control switches 12a-12c. The processing module 16 is connected to the control switches 12a-12c and the solar energy charging module 14, and the load 18 is connected to the control switches 12a-12c and the processing module 16. Furthermore, the processing module 16 further comprises a voltage detecting unit 160 connected to the control switches 12a-12c. As shown in FIG. 1, the processing module 16 controls the control switches 12a-12c to form close circuits between the batteries 10a-10c and the voltage detecting unit 160 correspondingly. In the meanwhile, the voltage detecting unit 160 can detect electricity of each of the batteries 10a-10c.

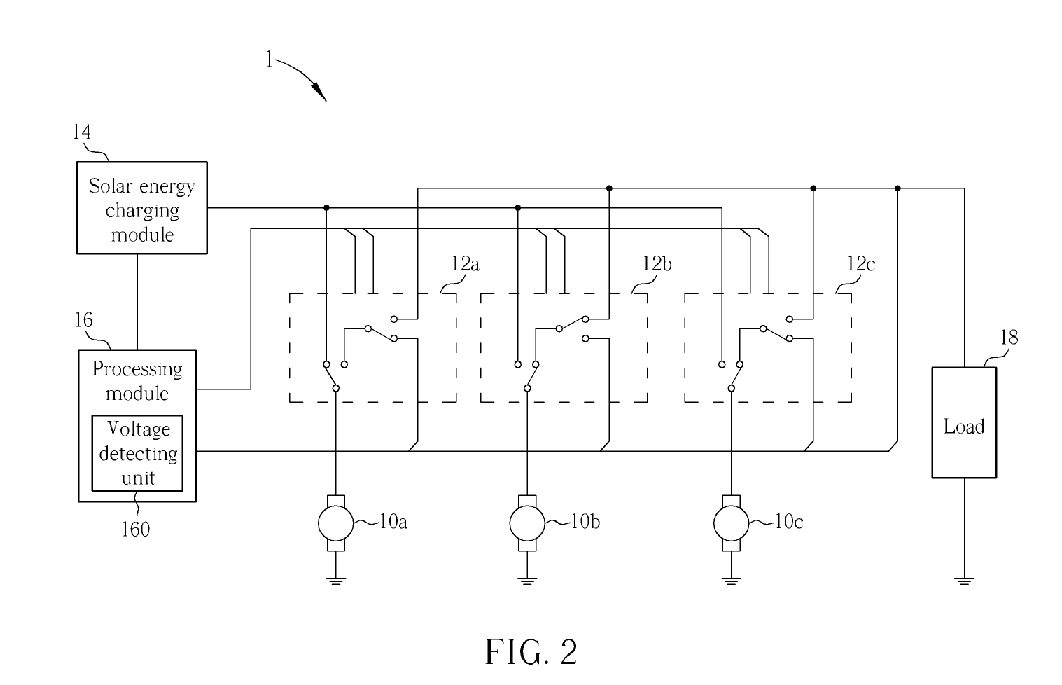

Referring to FIG. 2, FIG. 2 is a circuit diagram illustrating the three batteries 10a-10c being in charged state, power supplying state and idle state correspondingly. In this embodiment, when the processing module 16 judges a voltage of the first battery 10a is lower than voltages of the other two batteries 10b, 10c, the processing module 16 controls the corresponding first control switch 12a to form a close circuit between the first battery 10a and the solar energy charging module 14, such that the solar energy charging module 14 can charge the battery 10a. When the processing module 16 judges a voltage of the second battery 10b is higher than voltages of the other two batteries 10a, 10c, the processing module 16 controls the corresponding second control switch 12b to form a close circuit between the second battery 10b and the load 18, such that the battery 10b can discharge electricity to the load 18. When the processing module 16 judges a voltage of the third battery 10c is between voltages of the first battery 10a and the second battery 10b, the processing module 16 controls the corresponding third control switch 12c to form a close circuit between the third battery 10c and the voltage detecting unit 160, such that the voltage detecting unit 160 can continuously detect electricity of the battery 10c.

As shown in FIG. 2, when a close circuit is formed between the battery 10a with minimum electricity and the solar energy charging module 14, open circuits are formed between the other two batteries 10b, 10c and the solar energy charging module 14 accordingly. In other words, in this embodiment, the solar energy charging module 14 charges the battery 10a with minimum electricity. Furthermore, the battery 10b with maximum electricity discharges electricity to the load 18. It should be noticed that since the battery 10c is neither in charged state nor in power supplying state, the battery 10c is in idle state. After the solar energy charging module 14 completes charging the battery 10a, the processing module 16 detects voltages of each of the batteries 10a-10c and controls the corresponding control switches to enable the solar energy charging module 14 to charge another battery with minimum electricity.

It should be noticed that if the battery control system 1 of the invention comprises more than three batteries, the processing module 16 controls each of the control switches to form a close circuit between the battery with minimum electricity and the solar energy charging module 14, to form a close circuit between the battery with maximum battery and the load 18, and to form close circuits between the other batteries and the voltage detecting unit 160 respectively.

In this embodiment, the voltage detecting unit 160 can be an Analog to Digital Converter (ADC), and the processing module 16 can be a processor with data processing and signal control functions. Furthermore, the solar energy charging module 18 can comprise a plurality of solar energy charging circuits (that is, the solar energy charging module 18 can consist of a plurality of solar energy panels) so as to speed up charging.

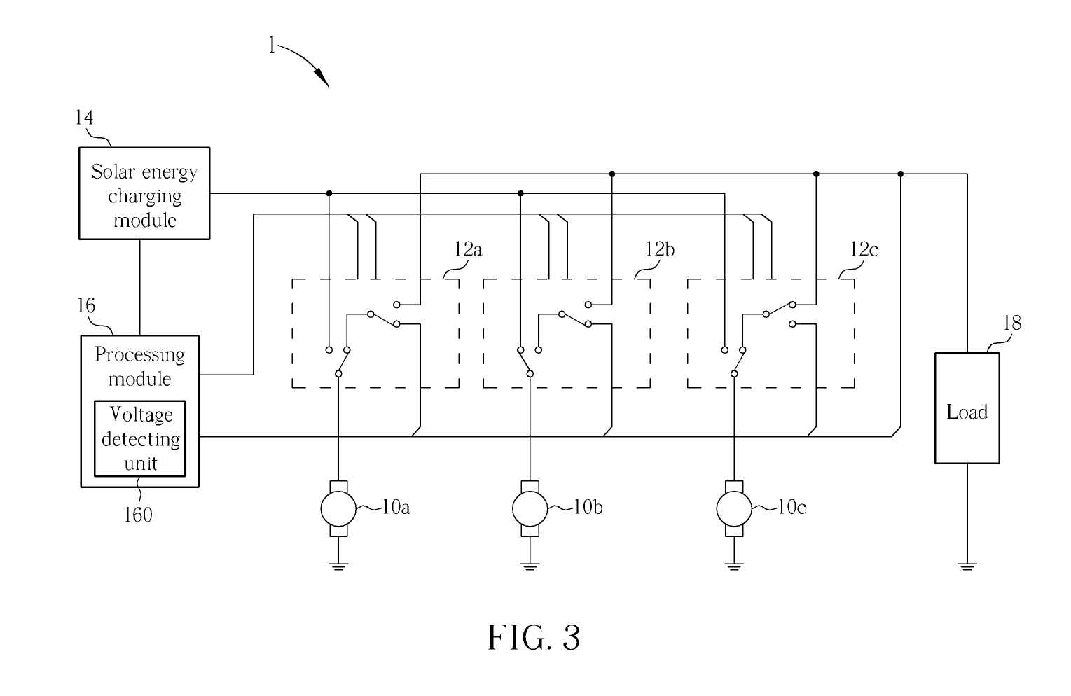

Referring to FIG. 3, FIG. 3 is a circuit diagram illustrating the three batteries 10a-10c being in idle state, charged state and power supplying state correspondingly. In this embodiment, when the second battery 10b continuously discharges until the voltage of the second battery 10b is lower than a predetermined voltage and its electricity is minimum, the processing module 16 controls the corresponding second control switch 12b to form a close circuit between the second battery 10b and the solar energy charging module 14 and controls the first control switch 12a to form an open circuit between the first battery 10a and the solar energy charging module 14. It should be noticed that the aforesaid predetermined voltage can be a minimum working voltage of the load 18 or can be arbitrarily set up by user.

Afterward, the processing module 16 judges which one of the batteries 10a, 10c has the largest electricity. For example, as shown in FIG. 3, when the third battery 10c has the largest electricity, the processing module 16 controls the corresponding third control switch 12c to form a close circuit between the third battery 10c and the load 18, such that the battery 10c can discharge electricity to the load 18. In the meanwhile, the processing module 16 controls the corresponding first control switch 12a to form a close circuit between the first battery 10a and the voltage detecting unit 160.

Please refer to FIG. 2 again. In another embodiment, after the solar energy charging module 14 charges the first battery 10a for a predetermined time or after the solar energy charging module 14 completes charging the first battery 10a, the processing module 16 controls the second control switch 12b to form a close circuit between the second battery 10b and the solar energy charging module 14 and controls the first control switch 12a to form an open circuit between the first battery 10a and the solar energy charging module 14. In other words, the processing module 16 controls the solar energy charging module 14 to automatically charge the next battery 10b after the predetermined time. If the battery 10a has been completely charged within the predetermined time, the processing module 16 controls the solar energy charging module 14 to automatically charge the next battery 10b, and time is reset simultaneously. If the battery 10a has not been completely charged within the predetermined time, the processing module 16 still controls the solar energy charging module 14 to automatically charge the next battery 10b. In such a manner, the solar energy charging module 14 can charge the batteries 10a-10c timely and sequentially. The aforesaid charging mechanism can be achieved by circuit design and signal control, and it will not be depicted herein. Furthermore, the aforesaid predetermined time can be arbitrarily set up by user, e.g. three minutes, five minutes and so on.

Compared to the prior art, according to the battery control system of the invention, each of the multiple batteries is connected to the solar energy charging module via one corresponding control switch respectively. Accordingly, the solar energy charging module can charge one of the multiple batteries by switching operations of the control switches. Furthermore, the voltage detecting unit of the processing module automatically detects electricity of each of the batteries by switching operations of the control switches, so as to control the solar energy charging module to charge the battery with insufficient electricity. Moreover, according to ranking of the electricity, the battery control system of the invention can control the solar energy charging module to automatically charge one single battery. Alternatively, after a predetermined time or after one of the batteries has been completely charged, the battery control system of the invention can control the solar energy charging module to automatically charge the next battery.

Those skilled in the art will readily observe that numerous modifications and alterations of the device and method may be made while retaining the teachings of the invention.

What is claimed is:

1. A battery control system comprising:
N batteries arranged in parallel, N being a positive integer larger than one;
N control switches, each of the control switches being connected to one of the batteries respectively;
a solar energy charging module connected to the control switches; and
a processing module connected to the control switches and the solar energy charging module, the processing module selectively controlling the i-th control switch to form a close circuit between the corresponding i-th battery and the solar energy charging module and controlling the other N−1 control switches to form open circuits between the corresponding N−1 batteries and the solar energy charging module, i being a positive integer smaller than or equal to N.

2. The battery control system of claim 1, wherein the processing module comprises a voltage detecting unit connected to the control switches, when M batteries of the batteries are idle, the processing module controls the corresponding M control switches to form close circuits between the M batteries and the voltage detecting unit, M is a positive integer smaller than N.

3. The battery control system of claim 1, wherein a voltage of the i-th battery is lower than voltages of the other N−1 batteries.

4. The battery control system of claim 1, wherein when a voltage of the j-th battery is lower than a voltage of the i-th battery, the processing module controls the corresponding j-th control switch to form a close circuit between the j-th battery and the solar energy charging module and controls the i-th control switch to form an open circuit between the i-th battery and the solar energy charging module, j is a positive integer smaller than or equal to N, and j is not equal to i.

5. The battery control system of claim 1, wherein after the solar energy charging module charges the i-th battery for a predetermined time, the processing module controls the j-th control switch to form a close circuit between the corresponding j-th battery and the solar energy charging module and controls the i-th control switch to form an open circuit between the corresponding i-th battery and the solar energy charging module, j is a positive integer smaller than or equal to N, and j is not equal to i.

6. The battery control system of claim 1, wherein after the solar energy charging module completes charging the i-th battery, the processing module controls the j-th control switch to form a close circuit between the corresponding j-th battery and the solar energy charging module and controls the i-th control switch to form an open circuit between the corresponding i-th battery and the solar energy charging module, j is a positive integer smaller than or equal to N, and j is not equal to i.

7. The battery control system of claim 1, further comprising a load connected to the control switches and the processing module, wherein when a voltage of the k-th battery is higher than voltages of the other N−1 batteries, the processing module controls the corresponding k-th control switch to form a close circuit between the k-th battery and the load, k is a positive integer smaller than or equal to N, and k is not equal to i.

8. The battery control system of claim 1, wherein the solar energy charging module comprises a plurality of solar energy charging circuits.
